(19) United States
(12) Patent Application Publication
(10) Pub. No.: US 2013/0233254 A1
(43) Pub. Date: Sep. 12, 2013

(54) Animal handler

(71) Applicant: Bozena Banach, Nokesville, VA (US)

(72) Inventor: Bozena Banach, Nokesville, VA (US)

(21) Appl. No.: 13/385,741

(22) Filed: Mar. 6, 2012

(51) Int. Cl. A01K 29/00; A01K 27/00; A01K 13/00; A01K 15/04

(52) U.S. Cl. 119/850; 119/856; 119/863

(57) ABSTRACT

This invention serves as a restraining and controlling device for animals. The invention allows quick mounting and fitting by using an adjustable neck strap with sliding buckle. The invention provides an optional hood for masking the animal's vision. The hood can prevent an animal from running and limit the animal's ability to bite. The invention can be further secured in place by the use of optional straps which wrap around the animal's chest, preventing the invention from moving up and/or forward. The invention provides a handle directly behind the animal's neck. This handle location allows the user to position the animal without the animal being in range to bite the user. With the hood deployed the invention allows for unobstructed access to the rear of the animal's head, and with the hood folded (not deployed) the user may also access the front of the animal's head.

### BACKGROUND OF THE INVENTION

### Description of Prior Art

Gloves offer protection to the operator in proportion to their thickness. Thicker gloves are more difficult for an animal to bite through. Thick gloves also limit the operator's ability to accurately move and feel their subject.

Muzzles can protect the user from being bitten. Solid muzzles also block the animal's vision, which prevents an animal from running away. A muzzle can be removed by an animal with sufficient dexterity to reach up-and-back to paw the muzzle's straps up-and-forward. The ability to secure varying muzzles with a strap around the back of the animal's head varies with the animal's head shape.

Animal's such as cats also have cat bags. These devices are a bag into which the animal is placed. They surround the animal's body and prevent the animal's limbs from having access to the operator. The animal is also unable to run away. Using this device, only the head of the animal is accessible. This poor accessibility limits the bag's usefulness.

A leash can be used to prevent an animal from running away. A leash provides no protection to the operator from animal bites. A leash is good for locating an animal, but has limited utility for positioning an animal.

The Animal Handler is designed to provide the benefits of the above mentioned tools while mitigating the drawbacks. The Animal Handler can provide bite protection like a glove and muzzle. It can also block the animal's vision, preventing the animal from running away like a solid muzzle or leash. It does not block access to most of the animal's body and back of the head, allowing for more utility than a bag. While the Animal Handler does not restrain an animal's limbs like a bag would, the blinding feature of the Animal Handler can reduce an animal's opportunity to target the operator with its limbs.

### BRIEF SUMMARY OF THE INVENTION

The Animal Handler is a tool to facilitate handling of an animal.

It features a neck strap which limits the animal's head's range of motion (Item 3 within figures). The neck strap is a loop which surrounds the animal's neck. The strap is sufficiently thick below the animals chin to not permit the animal to lower its head. When holding the animal by the chest below the face, the animal can not lower its head to bite the operator. The neck strap can be tightened sufficiently enough to not allow the animal to rotate within the neck strap. When the operator holds the neck strap the animal can not turn around to face the operator, further protecting the operator from bites.

The size and tightness of the neck strap is adjusted by a sliding buckle (Item 1 within figures). The sliding buckle has sufficient friction along the neck strap to stay in place after adjusted, but not so much friction as to be difficult for the operator to quickly adjust neck strap tightness. The sliding buckle allows for simple removal from an animal by loosening the neck strap and allowing for the invention to be slid off.

The sliding buckle delineates a portion of the neck strap for use as a handle (Item 2 within figures). The neck strap on the animal's side of the buckle is for surrounding the neck. The neck strap on the operator's side of the buckle serves as a handle for the operator to use. The invention as a whole, when viewed from above, appears as a figure-eight with one loop flattened, so as to form a ‘lolly pop’ shape (FIG. 8 most clearly demonstrates this shape).

Attached to the top circumference of the neck strap in the fore section is a hood (mask) (Item 4 within figures). The hood is soft and can be folded down flush against the inside circumference of the neck strap, effectively removing it from use (Item 4.2 within figures). If the operator wishes to blind the animal subject, the operator can deploy the hood over top of the animal's head (Item 4.1 within figures). This will blind the animal and inhibit the animal's ability to run away. While blind the animal would also be unable to accurately or reliably acquire a target for any aggressive action. The hood covers the mouth area of the animal, and would make it more difficult for the animal to successfully bite. The front most end of the hood has a small hole which allows the animal to breathe easily.

Should the operator need to more securely attach the invention to an animal, the operator may choose to use the under arm straps (Item 5 within figures) attached to the sliding buckle. These straps can be wrapped around the torso of the animal, under the animal's arms and around the front of the chest. The straps attach to each other with a basic binding mechanism (Item 6 within figures) such as Velcro. Once attached, these straps prevent the neck strap from riding up along the back of the animal's head, by securing the back of the neck strap's head-loop to the torso. This means that an animal which can reach behind its head with its paws is unable to remove the invention by sliding it up and forward.

### BRIEF DESCRIPTION OF THE SEVERAL VIEWS OF THE DRAWING

Figure Contents:

Label 1: Buckle

Label 2: Handle

Label 3: Neck restraint

Label 4.1: Mask/Hood (deployed)

Label 4.2: Mask/Hood (folded down)

Label 5: Securing straps

Label 6: Latch mechanism on securing straps

FIG. 1:

The invention installed on an animal, with all features employed.

The view is from the left side.

The hood is deployed to cover the face.

The buckle is slid forward to tighten the neck restraint around the cat's neck.

The strap is mounted around the cat's chest, securing the invention from being slid off upwards/forwards.

A portion of the neck restraint component located beyond the buckle (not around the cat's neck) serves as a handle.

The open area on the back of the mask/hood provides access to the back of the cat's head and neck.

FIG. 2:

The invention installed on an animal, with all features except the mask/hood which is folded down.

FIG. 2 is a variation of FIG. 1, with the hood not deployed.

The hood is folded down, and can be located flattened and pressed between the neck restraint and the cat's neck.

FIG. 3:

The invention viewed from the side with the mask/hood deployed.

FIG. 4:

The invention viewed from the side with the mask/hood folded down.

FIG. 5:

The invention viewed from a side-bottom perspective with mask/hood deployed.

FIG. 6:

The invention viewed from a side-bottom perspective with mask/hood folded down.

FIG. 7:

The invention viewed from an upper-rear perspective with the mask/hood deployed.

FIG. 8:

The invention viewed from an upper-side perspective with the mask/hood folded down.

FIG. 9:

The buckle and strap assembly. This is a sub component of the invention.

### DETAILED DESCRIPTION OF THE INVENTION

Process of Making^{.}

The neck strap is made from a flexible tube-like structure. This tube is bent into a loop, and attached to itself at the ends. The exact composition of the tube-like structure should be matched to the required application. Different animals and different size iterations of the invention may require different materials. Material choice should be adequate to form a structure soft enough to be formed into a loop and soft enough to be sufficiently compressed, but stiff enough to be held onto without flopping. Examples would include a rectangular piece of cloth rolled into a tube and stuffed with malleable material such as cotton, or a one-piece flexible polyurethane foam tube.

The neck strap is partially pulled through a small buckle so as to form a figure eight. The buckle may be circular, oval, rectangular, square, or any similar form. The buckle circumference should be slightly smaller than that of the circumference of the convex hull of two touching cross-sections of the neck strap tube. A properly sized buckle will allow the neck strap tube to be compressed and pulled through while providing adequate friction so as to prevent the buckle from sliding unintentionally.

The buckle may have a center divider, in a double-o-ring format (FIG. 9, item 1). When using a double-o-ring, the ends of the flexible tube must be individually pulled through each ‘o’ before being connected to form a loop. This allows the center divider of the double-o-ring to act as a stop, to prevent the double-o-ring buckle from sliding off of the neck strap tube.

The hood is a flat piece of material in the shape of an irregular fan, with the tip cropped. The material is partially rolled/folded so as to produce am incomplete truncated irregular cone. The orientation of the cone is on its side. The tip is front most, and the circular opening is rear most. The cone is incomplete because the ends of the fan do not touch to ‘close’ the conic. The cone is rotated along its axis so as to place the ends of the fan downwards. The cone is resting on top of the neck straps' front-most section, where it attaches along the upper circumference of the neck straps front loop. The truncated tip of the cone is the hood's breathing hole, located front-most on the invention. The back of the cone is the hood's rear opening.

The under-arm straps are long pieces of flat flexible material (FIG. 9, item 5). On one end, the material is threaded through the buckle and folded back onto itself (where it is attached to itself) forming a loop around the buckle. On the other end, the material is attached to one part of a binding mechanism. There are a total of two under-arm straps. On the end of the second under-arm strap is a binding mechanism which is the conjugate of the first under-arm strap's binding mechanism. An example would be a Velcro loop patch on the end of the first under-arm strap, and a Velcro hook patch on the end of the second under-arm strap. Together, these two under-arm straps form a ‘complete’ under-arm strap pair. The lengths of the under-arm straps are determined by the size of the animal for which the invention is being iterated. The lengths of each under-arm strap do not need to be identical to each other, however the total combined length after binding the two under-arm straps to each other should be appropriate for the chest circumference of the animal for which the invention is being iterated.

### Process of Using:

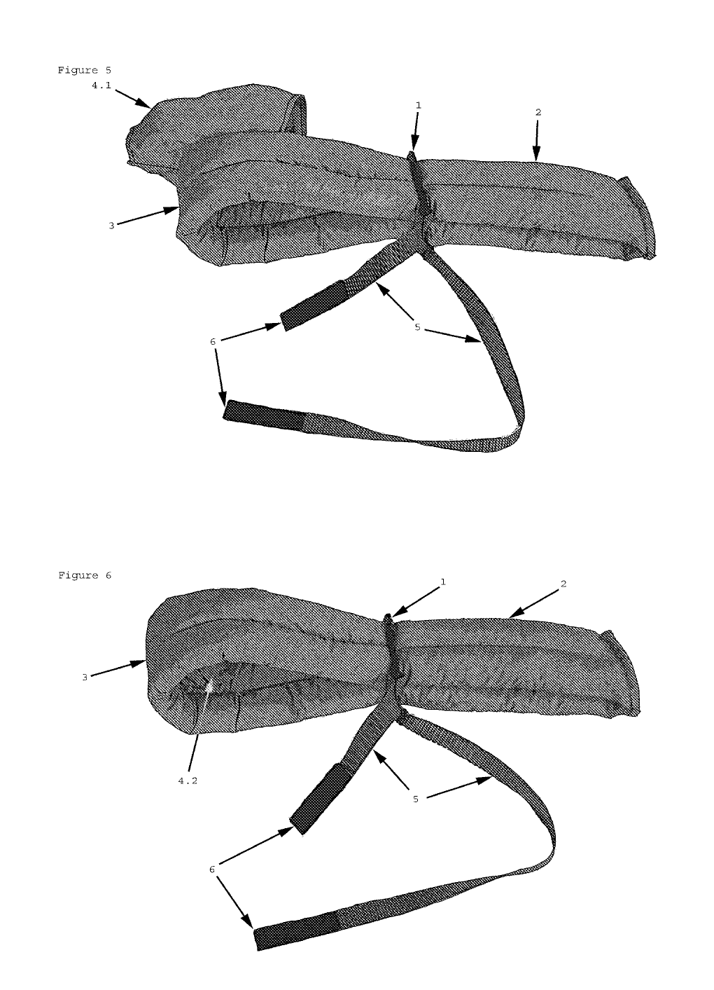

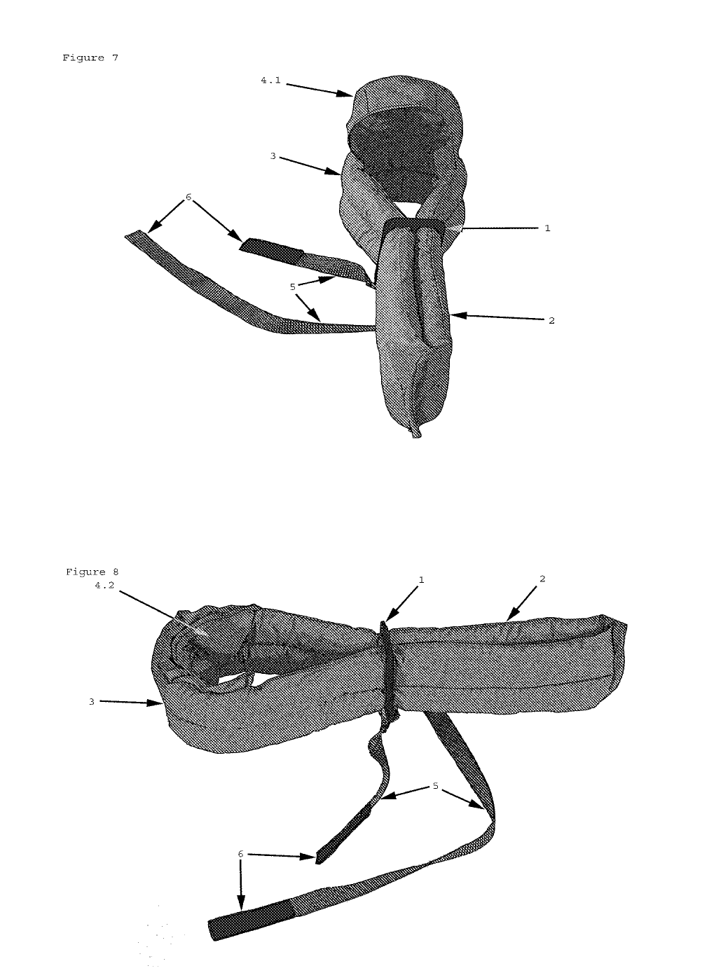

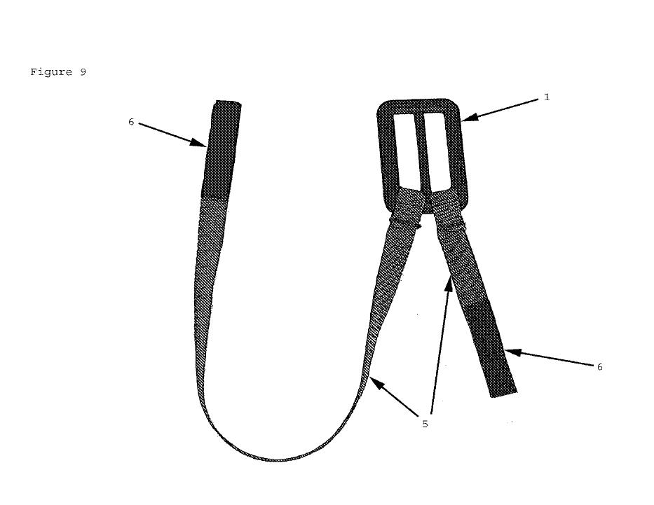

Before installing the invention onto an animal, first decide if the invention will be used with or without the hood. If the hood is not to be used, fold it down into the loop formed by the neck strap so that it lays flush along the front of the neck strap's inner circumference (FIG. 3 Item 4.1). If the hood will be used, deploy it upwards, so that it is fully formed and standing (FIG. 4 Item 4.2).

To install the invention on an animal, first move the sliding buckle rearward in order to enlarge the neck strap loop. When the neck strap loop is sufficiently large to go over the animal's head, slide the neck strap loop over the animal's head and down to the neck area. Once the neck strap is around the neck, move the sliding buckle forward to tighten the neck strap. Tighten so that the neck strap is snug around the animal's neck, but not choking the animal.

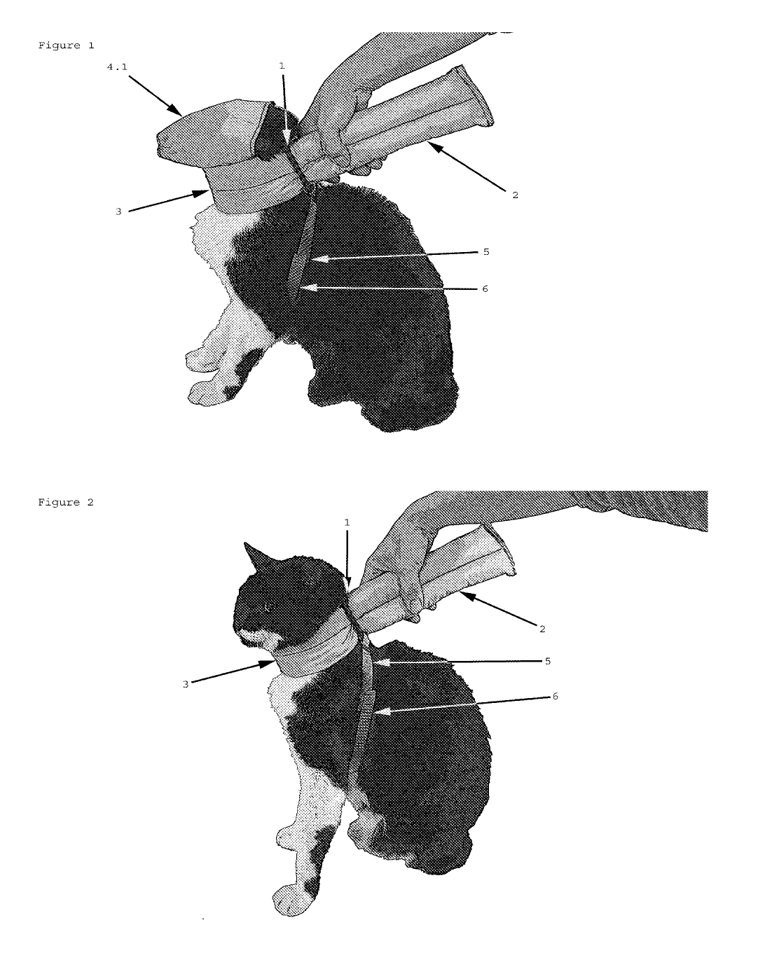

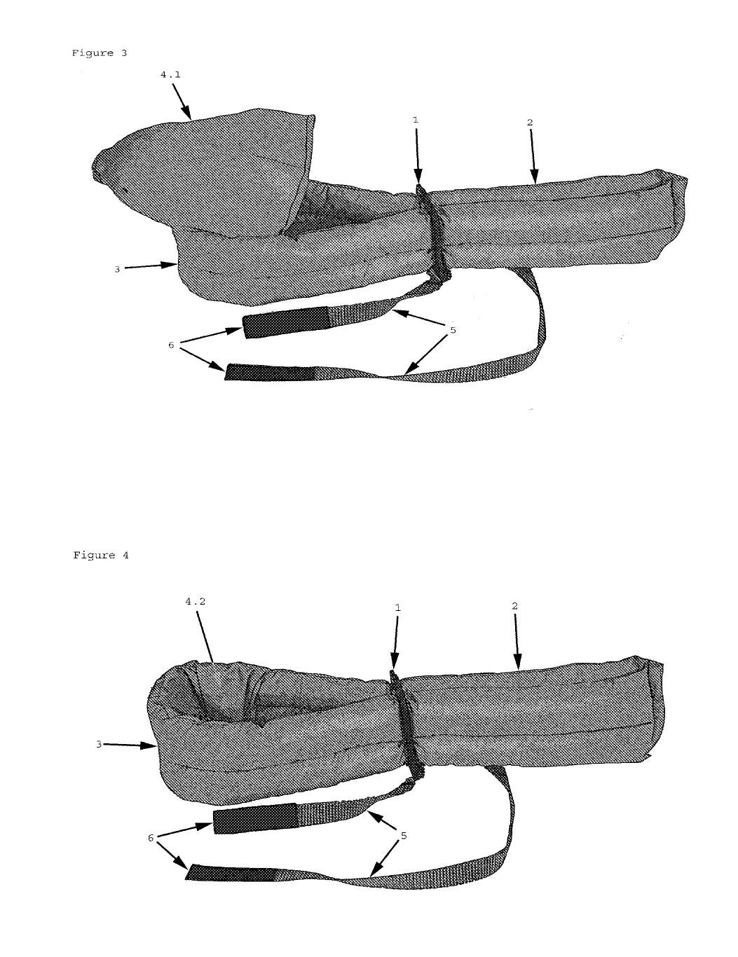

If the hood was not deployed, it will be tucked between the neck strap and the front of the animal's neck. If the hood was deployed, it will now be covering the front, sides, and top of the animal's head (FIG. 1 Item 4.1).

The portion of the neck strap behind the sliding buckle is to be used as a handle. The operator should hold onto the handle when manipulating the animal (FIG. 1 Item 4.1).

If the device needs to be further secured, the under arm straps should be placed under the animal's arms and around the animal's chest and secured to one another (FIG. 1 Items 5&6). This will prevent the animal from removing the invention by sliding it upwards.

### Distinguishing:

Unlike gloves, the animal handler is installed onto the subject rather than the operator. The animal handler does not inhibit the operator's hands.

Unlike a typical muzzle, the animal handler provides a handle, and the ability to blind the subject. A typical muzzle is vulnerable to being slid off upwards. The under arm straps prevent the animal handler from sliding off upwards.

Unlike a cat bag, the animal handler minimizes its impact on accessibility by covering only a minority of the animal's body.

Unlike a leash which only limits the location of an animal, the animal handler provides a handle with which to control the orientation of an animal.

1. The around the neck strap holds the invention onto an animal, limits head's range of motion, and additionally functions as a handle.

2. The sliding buckle allows for quick install, uninstall, and adjustment.

3. The hood blinds, limits ability to bite, limits ability to run.

4. The under arm straps additionally secure the invention, preventing it from sliding off upwards.
